(19) United States
(12) Patent Application Publication
(10) Pub. No.: US 2010/0020018 A1
(43) Pub. Date: Jan. 28, 2010

(54) SYSTEM AND METHOD FOR SELECTING MENU ITEMS OF AN ELECTRONIC APPARATUS

(75) Inventor: Jeng-Shyan Yang, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/423,820

(22) Filed: Apr. 15, 2009

(30) Foreign Application Priority Data
Jul. 25, 2008 (CN) 200810303066.2

(51) Int. Cl. G06F 3/02

(52) U.S. Cl. 345/169

(57) ABSTRACT

A method for selecting menu items of an electronic apparatus is provided. The method controls a keypad of the electronic apparatus to work in a circular input mode, determines whether a current input key is a first key, controls an indication cursor to highlight a first menu item of a menu item list if the current key is the first key, and checks a number pair comprised of a previous input key and the current key against a clockwise table or a counterclockwise table if the current key is not the first key. The method further generates clockwise sliding events to scroll the indication cursor down if the pair has a match in the clockwise table, or counterclockwise sliding events to scroll the indication cursor up if the pair has a match in the counterclockwise table, so as to select a desired menu item from the menu item list.

### BACKGROUND

1. Technical Field

Embodiments of the present disclosure relate to systems and methods for operating electronic apparatuses, and more particularly to a system and method for selecting menu items of an electronic apparatus.

2. Description of Related Art

Generally, an electronic apparatus typically includes a numerical keypad and a display screen, such as a screen of a cathode ray tube (CRT), a liquid crystal display (LCD) or the like. In order to help a user to easily understand and use the functions of the electronic apparatus, the display screen may display a plurality of menu items, and indicate a currently selectable menu item by highlighting that item in some way and/or displaying a cursor at that position.

In most cases, the user needs to press keys to navigate the cursor from one menu item to another menu item until the menu item they want is highlighted and becomes selectable. So much key pressing is inconvenient and wastes time.

Therefore, there is a improved system and method for selecting menu items of an electronic apparatus, which can overcome the above-mentioned problems.

### BRIEF DESCRIPTION OF THE DRAWINGS

FIG. 1 is a schematic diagram of one embodiment of a system for selecting menu items of an electronic apparatus.

FIGS. 2A-F are schematic diagrams illustrating the keys input in sequence when user's finger slides on a keypad in a sliding circular motion.

FIG. 3 is a schematic diagram of one embodiment of a clockwise table stored in a storage unit of FIG. 1.

FIG. 4 is a schematic diagram of one embodiment of a counterclockwise table stored in a storage unit of FIG. 1.

FIG. 5 is a flowchart of one embodiment of a method for selecting menu items of the electronic apparatus by the system of FIG. 1.

FIG. 6 is a schematic diagram of one embodiment of a selection mode of the electronic apparatus.

FIG. 7 is a schematic diagram of an example of selecting menu items by using the system of FIG. 1.

### DETAILED DESCRIPTION

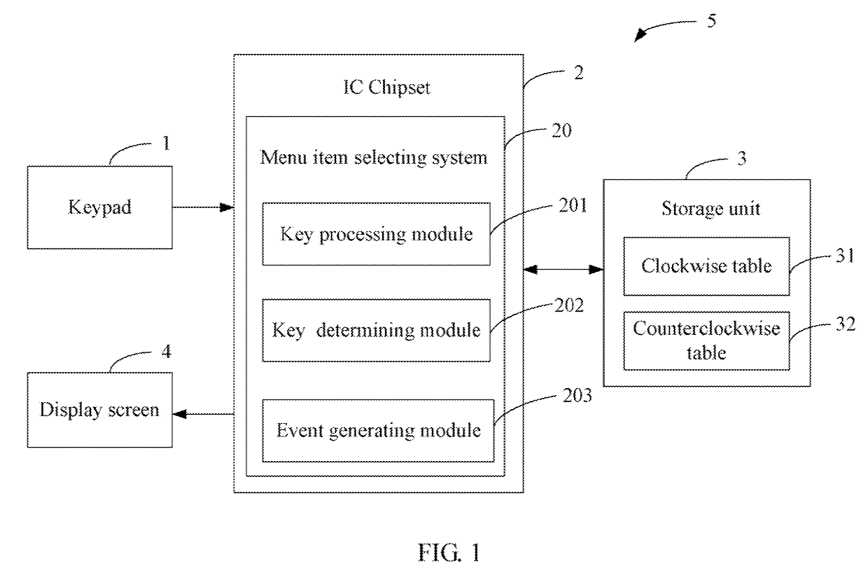

FIG. 1 is a schematic diagram of one embodiment of a system (hereinafter “menu item selecting system 20”) for selecting menu items of an electronic apparatus 5. In one embodiment, the menu item selecting system 20 is included in an integrated circuit (IC) chipset 2 of the electronic apparatus 5. In another embodiment, the menu item selecting system 20 may be included in an operating system of the electronic apparatus 5. The electronic apparatus 5 may include a keypad 1, the IC chipset 2, a storage unit 3, and a display screen 4. The electronic apparatus 5 may be a mobile phone, an MP3 device, a remote controller, and etc. The menu item selecting system 20 allows users select menu items by using one or more sliding circular motions on the keypad 1.

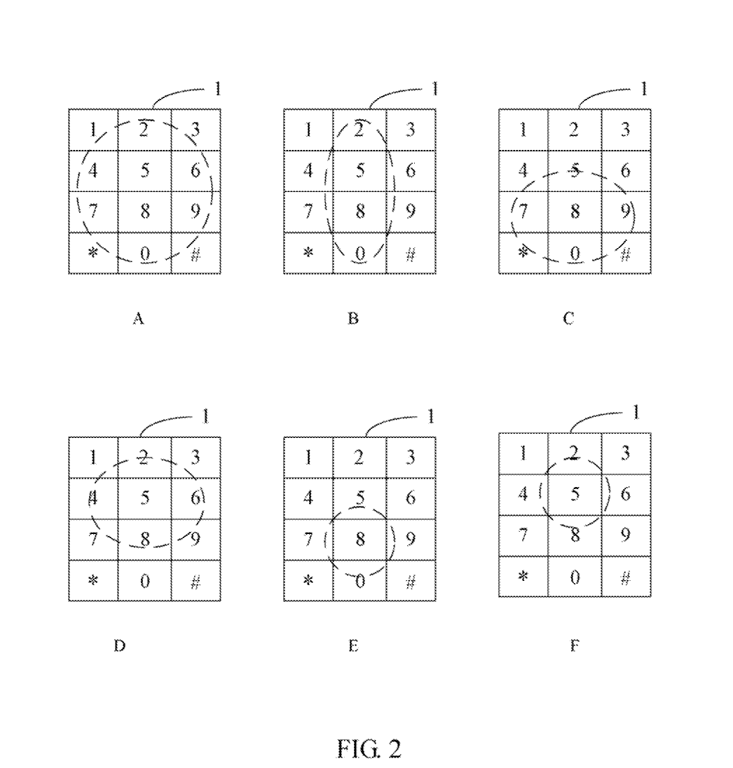

The keypad 1 may be a standard keypad having 12 keys, which include “0”-“9”, and the star “*” and pound “#” keys. In one embodiment, the “*” key may be regarded as a “10” key, and the “#” key regarded as an “11” key. Referring to FIG. 2, the twelve keys are arrayed in four rows and three columns (i.e., 4×3) as an example.

The IC chipset 2 includes the menu item selecting system 20, which may be a software program including a plurality of instructions that can be stored in a read only memory (ROM) embedded in the IC chipset 2, and can be executed by at least one processor of the electronic apparatus 5. The system 20 is operable to control the keypad 1 to work in a circular input mode for selecting menu items displayed on the display screen 4 when the user's finger slides on the keypad 1 for depressing one or more keys in quick succession. In the embodiment, the recognizable sliding input may be a clockwise or counterclockwise circular sliding motion. The pressing down and sliding across keys is considered a single input that ends when the user stops pressing. The sliding input may include only a clockwise or counterclockwise motion or combinations of both.

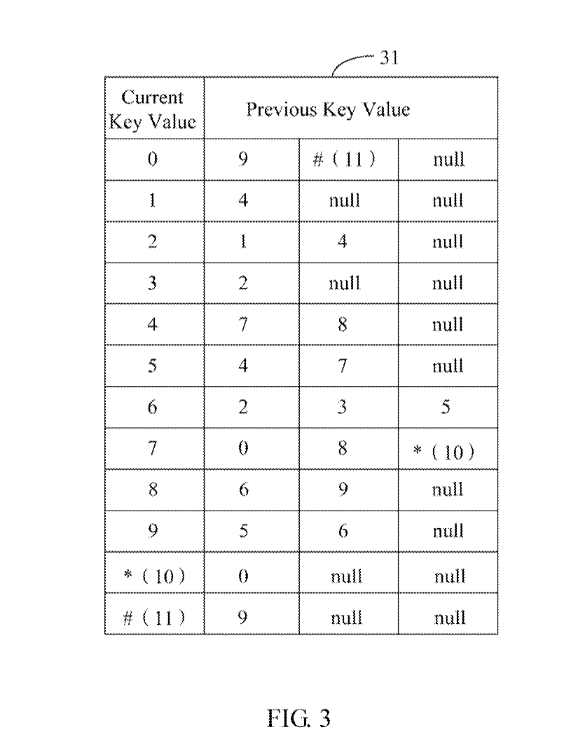

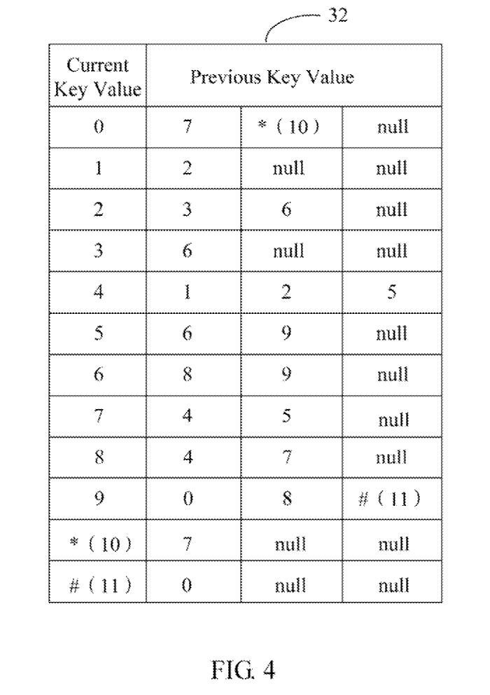

The storage unit 3 includes a clockwise table 31 and a counterclockwise table 32. In the clockwise table 31 (see FIG. 3), each key is associated with other keys that are possible prior inputs when there is a clockwise input. For example, a current key during an input may be “2”, if the “1” key or the “4” key was pressed just prior then it is known that the current input motion is clockwise. The counterclockwise table 32 (see FIG. 4) is built the same way as the clockwise table 31 but for the counterclockwise motion.

The display screen 4 is operable to display an indication cursor for highlighting a desired menu item of a menu item list displayed on the display screen 4 when there is a user input using the sliding circular motions on the keypad 1.

In one embodiment, the menu item selecting system 20 may include a key processing module 201, a key determining module 202, and an event generating module 203. Each of the function modules 201-203 can be executed by the at least one processor embedded in the IC chipset 2 of the electronic apparatus 5.

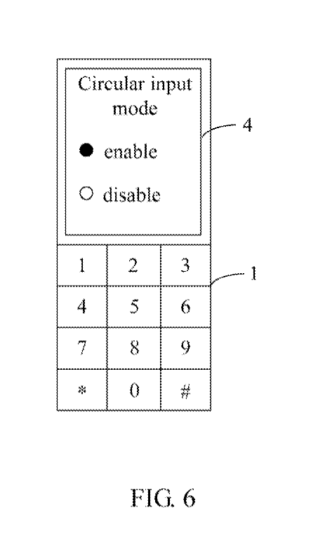

The key processing module 201 is operable to control the keypad 1 to selectably work in a normal input mode or a circular input mode according a user's selection displayed on the display screen 4. Referring to FIG. 6, the display screen 4 displays an enable selection and a disable selection. The key processing module 201 controls the keypad 1 to work in the circular input mode when the enable selection is selected, and in the normal input mode when the disable selection is selected.

The key determining module 202 is operable to determine whether the current key is a first key input in current input, and control the indication cursor to highlight the first menu item of a menu item list displayed on the display screen 4, if the current input key is the first key. Otherwise, if the current input key is not the first key, the key determining module 202 is operable to check a number pair comprised of a previous input key and a current input key in sequence against the clockwise table 31 or the counterclockwise table 32. For example, if any match is found in clockwise table 31, the key determining module 202 notifies the event generating module 203 to generate a clockwise sliding event to highlight next menu item of the menu item list in succession. If no match is found in clockwise table 31, the key determining module 202 checks the counterclockwise table 32.

The event generating module 203 is operable to generate a sliding event when the user's finger slides on the keypad 1, and scroll the indication cursor to select a desired menu item from the menu item list based on the sliding event. In one embodiment, the sliding event may be a clockwise sliding event when the user's finger slides on the keypad 1 in clockwise circular motions, and may be a counterclockwise sliding event when the user's finger slides on the keypad 1 in counterclockwise circular motions. For example, if the current input key has a previous key value in the clockwise table 31, the event generating module 203 scrolls the indication cursor down to highlight a menu item of the menu item list based on the clockwise sliding event. If the current input key has a previous key value in the counterclockwise table 32, the event generating module 203 scrolls the indication cursor up to highlight another menu item of the menu item list based on the counterclockwise sliding event.

FIGS. 2A-F are schematic diagrams illustrating the keys input in sequence when the user's finger slides on the keypad 1 in the sliding circular motions. In one embodiment, FIGS. 2A-F show six input sequences when the user's finger slides on the keypad 1 in the clockwise or counterclockwise motions, for example, an input sequence of “1>2>3>6>9>#>0>*>7>4>1”. Wherein the numbers “0”, . . . , “9” and the symbols “*” and “#” represent the twelve keys of the keypad 1, and the symbol “>” represents a sliding direction.

FIG. 3 is a schematic diagram of one embodiment of the clockwise table 31 stored in the storage unit 3 of FIG. 1. The clockwise table 31 records associations of possible valid previous key values with current key input from the keypad 1 when the user's finger slides on the keypad 1 in clockwise circular motions. In the embodiment, the clockwise table 31 can associate up to three key values as previous inputs to a current input, where there are less than three the empty boxes are null. For example, in the clockwise table 31, the key values “9” and “#” are associated as valid previous input values with the current key input of “0”, and the key values “1” and “4” are associated with the current key input of “2”.

FIG. 4 is a schematic diagram of one embodiment of the counterclockwise table 32 stored in the storage unit 3 of FIG. 1. The counterclockwise table 32 is similar to the clockwise table 31 except that it records associations of possible valid previous key values for counterclockwise circular motions.

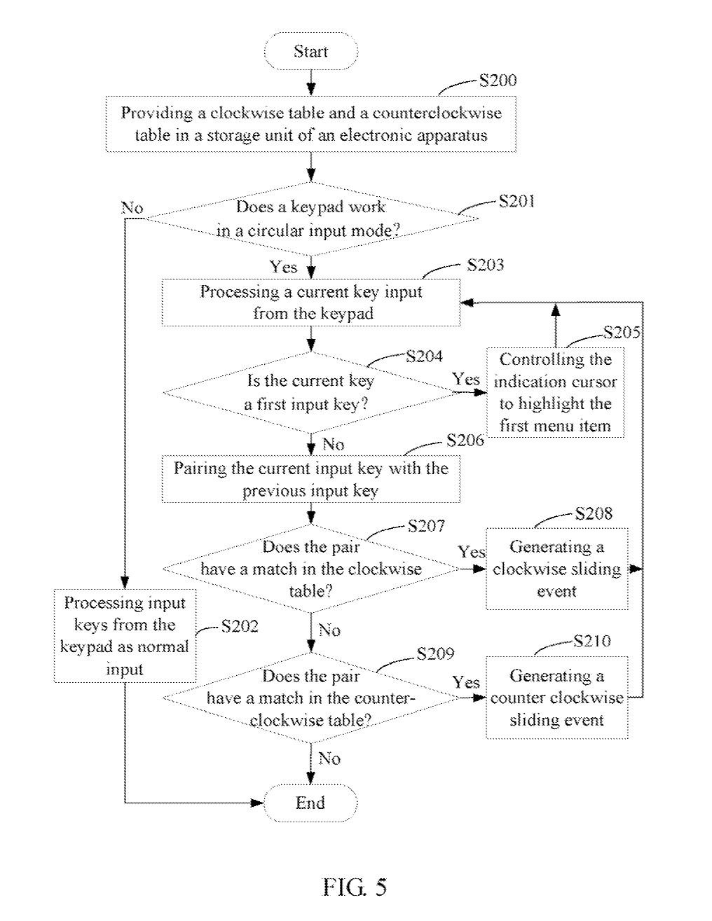

FIG. 5 is a flowchart of one embodiment of a method for selecting menu items of an electronic apparatus 5 using the system 20 of FIG. 1 as described above. Depending on the embodiment, additional blocks may be added, others removed, and the ordering of the blocks may be changed.

In block S200, a manufacturer of the electronic apparatus 5 provides and stores a clockwise table 31 and a counterclockwise table 32 in a read only memory (ROM) embedded in the IC chipset 2 or the storage unit 3 of the electronic apparatus 5.

In block S201, the key processing module 201 determines whether the keypad 1 works in a circular input mode according to a selection mode displayed on the display screen 4. In the embodiment, the key processing module 201 controls the keypad 1 to work in the circular input mode when the enable selection is selected. Otherwise, the key processing module 201 controls the keypad 1 to work in the normal input mode when the disable selection is selected.

If the keypad 1 works in the normal input mode, in block S202, the key processing module 201 processes input key from the keypad 1 as normal input until such time the selection mode is changed. Otherwise, if the keypad 1 works in the circular input mode, in block S203, the key processing module 201 processes input keys from the keypad 1 as scroll commands for selecting a desired menu item of a menu item list displayed on the display screen 4.

In block S204, the key determining module 202 determines whether the current key is a first input key according to a current input sequence. If the current key is the first input key, in block S205, the key processing module 201 controls the indication cursor to highlight to the first menu item of the menu item list, and the procedure returns to block S203 as described above. Otherwise, if the current input key is not the first input key, in block S206, the key determining module 202 saves the current key value to pair up with the next input key, and pairs the current input key with the previous input key according to the current input sequence. In block S207, the key determining module 202 checks if the pair has a match in the clockwise table 31.

If the pair has a match in the clockwise table 31, in block S208, the event generating module 203 generates a clockwise sliding event for scrolling the indication cursor down or right to highlight a menu item next to the previous menu item, and the procedure returns to block S203. Otherwise, if the pair has no match in the clockwise table 31, in block S209, the key determining module 202 checks whether the pair has a match in the counterclockwise table 32.

If the pair has a match in the counterclockwise table 32, in block S210, the event generating module 203 generates a counterclockwise sliding event for scrolling the indication cursor up or left to highlight a menu item next to the previous menu item, and the procedure returns to block S203. Otherwise, if the pair has no match in the counterclockwise table 31, the procedure ends.

FIG. 6 is a schematic diagram of one embodiment of the selection mode of the electronic apparatus 5. In one embodiment, the display screen 4 displays two selections that include an enable selection and a disable selection. The keypad 1 works in a circular input mode when the enable selection is selected. Otherwise, the keypad 1 works in a normal input mode when the disable selection is selected. When the keypad 1 works in the circular input mode, the menu item selecting system 20 processes input keys from the keypad 1 as scroll commands to select a desired menu item from the menu item list displayed on the display screen 4. Otherwise, the electronic apparatus 5 processes input key from the keypad 1 as normal input until such time the selection mode is changed.

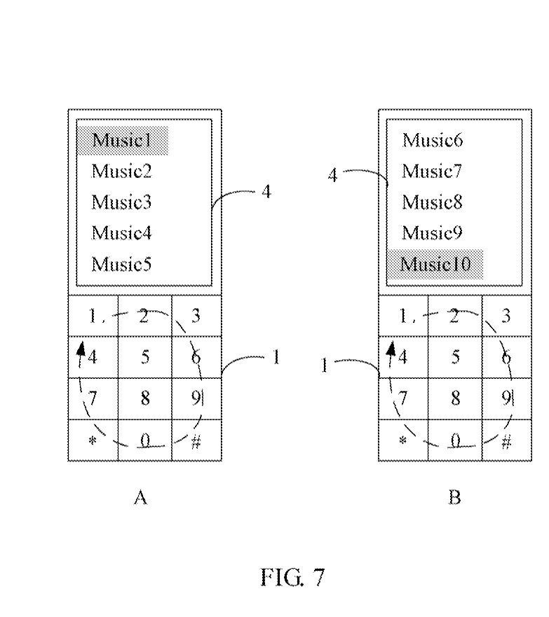

FIG. 7 is a schematic diagram of an example of selecting menu items using the system 20. According to the above-described procedures, the example of selecting menu items by utilizing the system 20 is shown and described below. Assuming that the user's finger slides on the keypad 1 in clockwise circular motions, and the keys “1>2>3>6>9>#>0>*>7>4” are input in sequence. As the first key “1” is input, the indication cursor of the display screen 4 highlights the first menu item, e.g., Music1 (see FIG. 7A). The key value determining module 202 pairs each input key with the previous input key, and looks up the pair in the two tables, i.e., the clockwise table 31 and the counterclockwise table 32. The event generating module 203 generates a clockwise sliding event to highlight the next menu item by scrolling down the indication cursor. After look up the previous input key is discarded and the present one kept for pairing with the next input. As a result, the indication cursor can be easily navigated to the desired menu item, which is the tenth menu item displayed on the display screen 4, e.g., music10 (see FIG. 7B).

All of the processes described above may be embodied in, and fully automated via, functional code modules executed by one or more general purpose processors or electronic devices. The functional code modules may be stored in any type of readable medium or other storage device. Some or all of the methods may alternatively be embodied in specialized the electronic devices.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for selecting menu items of an electronic apparatus, the electronic apparatus comprising a keypad, a display screen, and a storage unit, the system comprising:
a key processing module operable to control the keypad to work in a circular input mode when an enable selection displayed on the display screen is selected;
a key determining module operable to determine whether a current key input from the keypad is a first key according to a current input sequence, control an indication cursor to highlight a first menu item of a menu item list displayed on the display screen if the current input key is the first key, and check a number pair comprised of a previous input key and the current input key against a clockwise table or a counterclockwise table stored in the storage unit if the current input key is not the first key; and
a event generating module operable to generate clockwise sliding events for scrolling the indication cursor down to select a desired menu item from the menu item list displayed on the display screen if the pair has a match in the clockwise table, or generate counterclockwise sliding events for scrolling the indication cursor up to select a desired menu item from the menu item list if the pair has a match in the counterclockwise table.

2. The system according to claim 1, wherein the keypad comprises twelve keys being arranged in a four rows and three columns (4×3) pattern.

3. The system according to claim 1, wherein the clockwise table records associations of possible valid previous key values with the current input key from the keypad when a user's finger slides on the keypad in clockwise circular motions.

4. The system according to claim 1, wherein the counterclockwise table records associations of possible valid previous key values with the current input key from the keypad when a user's finger slides on the keypad in counterclockwise circular motions.

5. The system according to claim 1, wherein the key processing module is further operable to control the keypad to work in a normal input mode when a disable selection displayed on the display screen is selected.

6. A method for selecting menu items of an electronic apparatus, the electronic apparatus comprising a keypad, a display screen, and a storage unit, the method comprising:
(a) providing a clockwise table and a counterclockwise table in the storage unit;
(b) controlling the keypad to work in a circular input mode according to a selection mode displayed on the display screen;
(c) processing a current key input from the keypad as a scroll command;
(d) determining whether the current input key is a first input key according to a current input sequence;
(e) setting an indication cursor to highlight the first menu item of a menu item list displayed on the display screen and then going to step (c), if the current input key is the first input key;
(f) saving the current key value to pair up with the next input key and pairing the current input key with the previous input key according to the current input sequence if the current input key is not the first input key;
(g) checking whether the pair has a match in the clockwise table; and
(h) generating a clockwise sliding event to scroll the indication cursor down to highlight a next menu item of the menu item list if the pair has a match in the clockwise table, and going to step (c); or
(i) checking whether the pair has a match in the counterclockwise table if the pair has no match in the clockwise table; and
(j) generating a counterclockwise sliding event to scroll the indication cursor up to highlight a next menu item of the menu item list if the pair has a match in the counterclockwise table, and going to step (c).

7. The method according to claim 6, wherein the selection mode is an enable selection for controlling the keypad to work in the circular input mode, or a disable selection for controlling the keypad to work in a normal input mode.

8. The method according to claim 7, further comprising:
processing input keys from the keypad as normal input until such time the selection mode is changed if the keypad works in the normal input mode.

9. The method according to claim 6, wherein the keypad comprises twelve keys being arranged in a four rows and three columns (4×3) pattern.

10. The method according to claim 6, wherein the clockwise table records associations of possible valid previous key values with the current input key from the keypad when a user's finger slides on the keypad in clockwise circular motions.

11. The method according to claim 6, wherein the counterclockwise table records associations of possible valid previous key values with the current input key from the keypad when a user's finger slides on the keypad in counterclockwise circular motions.

12. A medium having stored thereon instructions that, when executed by an electronic apparatus, cause the electronic apparatus to perform a method for selecting menu items of the electronic apparatus, the method comprising:
(a) providing a clockwise table and a counterclockwise table in a storage unit of the electronic apparatus;
(b) controlling the keypad works in a circular input mode according to a selection mode displayed on the display screen;
(c) processing a current key input from the keypad as a scroll command;
(d) determining whether the current input key is a first input key according to a current input sequence;
(e) setting an indication cursor to highlight the first menu item of a menu item list displayed on the display screen and then going to step (c), if the current key is the first input key;
(f) saving the current key value to pair up with the next input key and pairing the current input key with the previous input key according to the current input sequence if the current key is not the first input key;
(g) checking whether the pair has a match in the clockwise table; and
(h) generating a clockwise sliding event to scroll the indication cursor down to highlight a next menu item of the menu item list if the pair has a match in the clockwise table, and going to step (c); or
(i) checking whether the pair has a match in the counterclockwise table if the pair has no match in the clockwise table; and
(j) generating a counterclockwise sliding event to scroll the indication cursor up to highlight a next menu item of the menu item list if the pair has a match in the counterclockwise table, and going to step (c).

13. The medium according to claim 12, wherein the selection mode is an enable selection for controlling the keypad to work in the circular input mode, or a disable selection for controlling the keypad to work in a normal input mode.

14. The medium according to claim 13, further comprising:
processing input keys from the keypad as normal input until such time the selection mode is changed if the keypad works in the normal input mode.

15. The medium according to claim 12, wherein the keypad comprises twelve keys being arranged in a four rows and three columns (4×3) pattern.

16. The medium according to claim 12, wherein the clockwise table records associations of possible valid previous key values with the current input key from the keypad when a user's finger slides on the keypad in clockwise circular motions.

17. The medium according to claim 12, wherein the counterclockwise table records associations of possible valid previous key values with the current input key from the keypad when a user's finger slides on the keypad in counterclockwise circular motions.
